(19) United States
(12) Patent Application Publication
(10) Pub. No.: US 2019/0088242 A1
(43) Pub. Date: Mar. 21, 2019

(54) Acoustic Absorber for Sound Screen Implementation in Earphones and Headphones

(71) Applicants: Larry Tang, Pacific Grove, CA (US); Peter Fuhsien Tang, Pacific Grove, CA (US); Alexander Fuwai Tang, Pacific Grove, CA (US)

(72) Inventors: Larry Tang, Pacific Grove, CA (US); Peter Fuhsien Tang, Pacific Grove, CA (US); Alexander Fuwai Tang, Pacific Grove, CA (US)

(21) Appl. No.: 15/708,555

(22) Filed: Sep. 19, 2017

(51) Int. Cl. G10K 11/168

(52) U.S. Cl. CPC G10K 11/168

(57) ABSTRACT

An acoustic absorber including a layer of nonporous elastic polymer overlying and adhesively bonded to a layer of porous material, with central portions of each arched to provide a dome-shape configuration with respect to their opposing ends, and with pluralities of such layers implementable to form a sound screen for earphone and headphone assemblies.

### CROSS-REFERENCE TO RELATED APPLICATIONS

None.

### STATEMENT REGARDING FEDERALLY SPONSORED RESEARCH OR DEVELOPMENT

Research and development of this invention and Application have not been federally sponsored, and no rights are given under any Federal program.

### REFERENCE TO A MICROFICHE APPENDIX

NOT APPLICABLE

### BACKGROUND OF THE INVENTION

### Field of the Invention

This invention relates to acoustic absorbing sound screens, in general, and to an acoustic absorber construction that provides an effective damping of undesirable frequencies that cause discomfort and fatigue to wearers of earphone and headphone assemblies.

### Description of the Related Art

As will be appreciated by those skilled in the art, several types of acoustic absorbers have been proposed for sound damping in loudspeaker constructions. Whatever the absorbers may be—whether plastic or plastic film (with or without additional embedded layers), paper or paper fiber, or various combinations of natural and synthetic fibers (in the form of mats or otherwise)—such arrangements have been found to be less than successful in adaptation to the moving coil technology utilized in earphone and headphone system constructions.

### OBJECTS OF THE INVENTION

It is an object of the present invention to provide an innovative acoustic absorbing sound screen for these kinds of audio listenings.

It is another object of the invention, moreover, to provide such an acoustic absorbing sound screen applicable in all types of transportable speaker units.

### SUMMARY OF THE INVENTION

As will become clear from the following description, the acoustic absorbing sound screen of the invention (hereinafter simply referred to as “sound screen”) is of substantially “dome shape”, as contrasted with the flat type of acoustic absorber characterizing the prior acoustic absorber art.

In its design, the sound screen includes a plurality of acoustic absorbers, each formed of a layer of porous material adhesively secured beneath a layer of nonporous elastic polymer substrate, with central portions of each layer being correspondingly raised with respect to the opposing ends of each of the two layer lengths. In a preferred embodiment, each layer is first drawn, and then cut to its respective length—and, further for ease of implementation, with diameters at each of their opposing ends greater than at their central, raised, dome-like portion. Additionally—again for ease of implementation in the sound screen, the layer of porous material may be of a somewhat shorter length than the layer of nonporous elastic polymer substrate—so as to be secured substantially equally between opposite ends of the substrate.

In accordance with the invention, the top layer of non-porous elastic polymer substrate is composed of a material more pliable and stretchable than that of the lower layer of porous material. At the bottom of the lower layer, the voice coil attachments of the earphone, headphone and transportable speaker units are connected. Selecting the lower layer of porous material of slightly smaller length than the top layer of nonporous elastic polymer substrate allows the vibration energy from the voice coil to bounce the top layer in increasing the transfer of energy in the speaker when formed in the sound screen, thereby overcoming “screechiness” and any other ear damaging undesirable sounds. In essence, a deeper resonance results at the lower bass frequencies.

### BRIEF DESCRIPTION OF THE DRAWINGS

These and other features of the invention will be more clearly understood from a consideration of the following description, taken in connection with the accompanying drawings in which:

FIGS. 1A-1D are helpful in an understanding of the acoustic absorber for implementation into the sound screen of the invention;

FIGS. 2 and 3 are sectional views helpful in an understanding of the incorporation of the acoustic absorber layer in a headphone assembly housing;

FIGS. 4-9 are helpful in understanding of the incorporation of the acoustic absorbing sound screen into an earphone or head phone assembly housing.

### DETAILED DESCRIPTION OF THE INVENTION

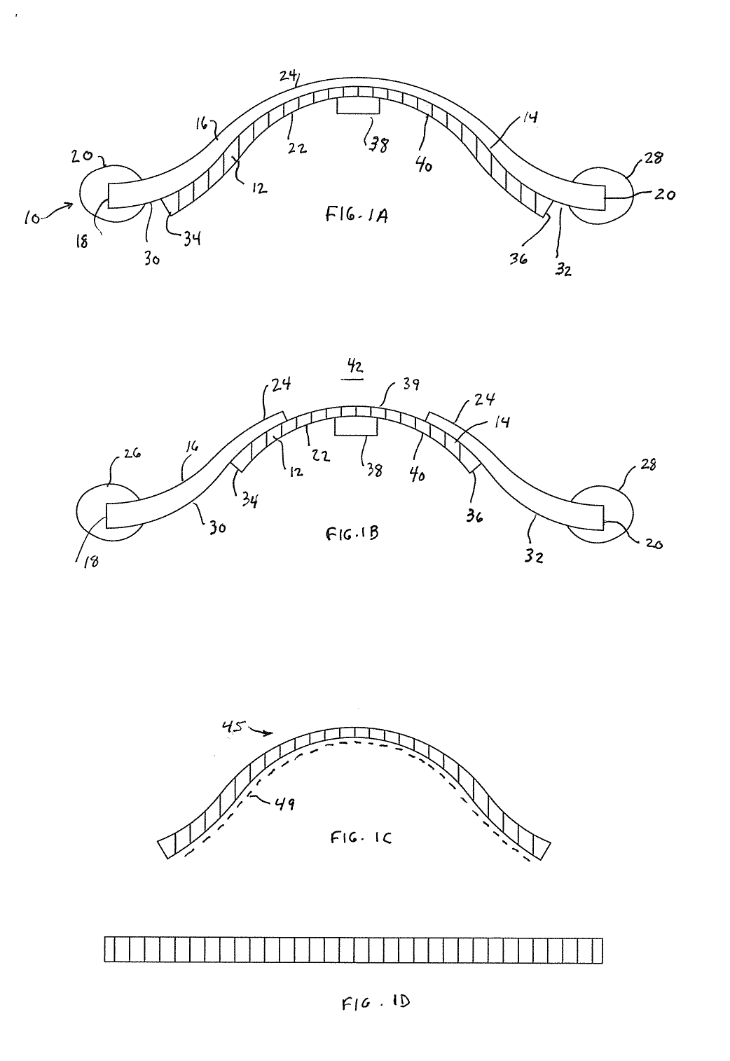

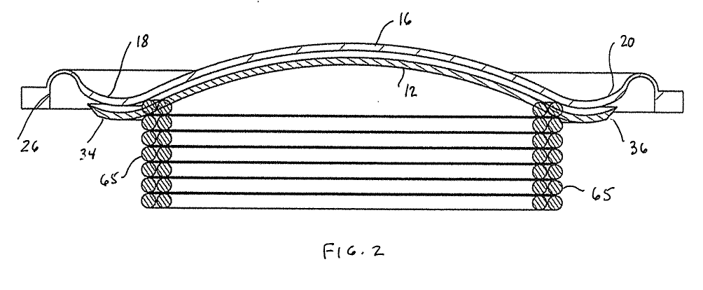

In FIGS. 1A-1D, a sectional view of the acoustic absorber for the sound screen 10 includes a layer of porous material 12 of a first length adhesively secured at 14 beneath a layer of nonporous elastic polymer substrate 16 of a second length—and substantially equally spaced between opposite ends 18, 20 of the nonporous substrate 16 in a preferred defined composite lamination where the substrate 16 is of a greater length. Central portions of each layer are correspondingly raised at 22, 24 with respect to the opposite ends of each layer in providing an arch forming a “dome shape”, with the ends 18, 20 of the substrate layer 16 secured to a pair of metal rings 26, 28—part of a headphone housing assembly construction to be described below. In this preferred embodiment, each of the layers 12, 16 are first drawn to a diameter greater at their opposing ends than at their central, raised portions, 22, 24, and then cut to their desired lengths. Shown at 30, 32, the nonporous elastic polymer substrate 16 overlaps the porous layer 12, whose opposing ends are shown at 34, 36. A voice coil 38 of appropriate construction is connected to the bottom surface 40 of the porous layer 12. As will become clear below, the greater length of the substrate 16 eases a “crimping” of the adversely secured layers to the metal rings 26, 28.

For one speaker assembly using the acoustic absorber of the invention, FIG. 1B shows a hole 39 in the middle length area 42 of the nonporous elastic polymer substrate 16, not present in the alternative sound screen embodiment of FIG. 1A for a second speaker assembly. As illustrated in FIG. 1A, the ends 34, 36 of the porous layer 12 are of smaller diameter than at the ends 18, 20 of the nonporous elastic polymer substrate 16 when joined in the headphone assembly housing, but drawn to a larger diameter at the middle length area 42. In FIG. 1B, the same relationships exist with respect to the ends 34, 36 and 18, and where the nonporous elastic polymer substrate 16 overlaps.

FIG. 1D illustrates the original stock shape of the porous material and the non-porous elastic polymer substrate before being drawn to an arch of the “dome shape” 45, and cut (FIG. 1C). A very thin layer of nonporous elastic polymer material 49 could also be adhesively secured there, at the bottom of the porous layer 12 for added support before being drawn and cut.

In fabricating the acoustic absorber 10, the porous layer 12 can be of a high quality paper stock, available in sheets—with pulp and/or linen fibers—and may be laced as well with carbon fibers or with any other porous material. Many such dome shaped formations are formed in each sheet, and then stamped out. The bottom layer 12, however, is preferably made of a flat sheet stock available as a roll, each drawn to the “dome shape”, to be then individually cut or punched out. The nonporous elastic polymer substrate 16, may be a nonporous pliable thermoplastic (preferably polyurethane or other pliable and stretchable rubbery material). Such substrate, also, could be made from a sheet stock of a non-expanded or pre-expanded polyurethane, drawn to shape, and cut—or injection molded to the length and shape from a non-expanded polyurethane raw material. Alternatively, as will be understood, other pliable and stretchable plastic materials could be used for the layers 12 and 16 as well.

According to the invention, the porous layer 12 sheet stock material is selected to be not as pliable and stretchable as that of the nonporous elastic polymer substrate layer 16—and by the shaping process of drawing the two layers (as with a thermo drawn process), the substrate layer area near the crest of the dome will be thinner than that of the porous layer in the same area (and, also, to exist without the presence of any crease). Such particular shaping of the layer 16 depends upon the thickness of the material chosen (as well as the material itself), so that together with the porous material layer, different sound frequencies will be gathered from one, to be transferred and resonate the other. Due to the fact that the area near the crest of the dome of the substrate layer is slightly thinner than that of the porous layer there (gradually decreasing from the lower ends to the top of the crest), the combination of the two layers 12 and 16 can be tuned to a desired musical frequency at different areas of a resulting sound screen formed of many such acoustic absorbers, noting that the two layers are preferably made to a rounded shape with a rounded base. Although square bases could be used as well, different thicknesses of the dome shapes made by the drawing process will allow vibration at the various regions or spots. A porous material is desired for the layer 12 as it will provide more mellow sound than just a hard plastic sheeting, yet with just the right property for an acoustic absorbing of high, middle and low sound frequencies. To have the best result to generate a pleasing overall listening appearance, a proper choice of materials for the porous layer and nonporous elastic polymer substrate should be made.

As will be evident, the two layers 12 and 16 are adhesively secured to form a bond without any gap between the two layers. A certified bonding agent with a good quality, and environmentally friendly would be desirable. An epoxy cement may be employed for such purpose.

The porous layer 12, on the other hand, could also be made with a gradual thickness, thicker at the bottom and thinner at the top (FIG. 1C) instead of starting with an even thickness as shown in FIG. 1D—depending on the sound absorption effect desired. There, the porous layer 12 could continue flush with the nonporous substrate 16 (leaving, however, some exposed non-covered area as illustrated) as in FIGS. 1A and 1B. And, as indicated, the top of the nonporous elastic polymer substrate 16 could be made with a hole in the middle, or without any hole as shown in these two FIGURES.

As illustrated in FIGS. 1A and 1B, a voice coil 38 of the earphone or headphone speaker is attached to the bottom of the porous layer 12—its top being bonded to the bottom surface of the porous material 12 at the underside of the crest, whether the nonporous substrate is provided with such a hole as 59 or not.

FIGS. 2 and 3 in these respects show the voice coil at 65, the ends 34, 36 of the porous layer 12, and the ends 18, 20 of the longer substrate 16 (which are crimped to a lesser diameter and thickness and secured in place at the rings 26, 28 of a ring-shaped metal frame 70 of the housing assembly 77). (FIG. 3 in this manner, is an enlargement of FIG. 2 showing the pre-assembled voice coil speaker component housing 70 with the internal sectional views. The voice coil is shown at 65, a printed circuit board at 73, a rivet securement at 75, an encompassing steel washer at 78, a magnet at 79 and a cover at 80. The sound screen of the invention, with its layers 12 and 16, for the totality of acoustic absorbers, is shown.

At the two edge/rings 26, 28 of the metal frame 70, the overlap 30, 32 of the nonporous elastic polymer substrate 16 is indicated, so that when vibration energy from the voice coil at is transferred from the underlying porous layer 12, the substrate 16 can bounce to generate a greater sound to the wearer of the earphone or headphone assembly in overcoming any sound frequencies less than desirable for purposes of comfort hearing. By virtue of the crimping of the substrate ends 18, 20 to the ring-shaped metal frame 70 with the porous layer laminated to the substrate 16, the exposed metal rim 50 so formed (FIGS. 8 and 9) vibrates differently from the laminated layers. This allows a designing into the sound screen of the invention of an acoustic effect even more selectable than by just changing the lengths and diameters of the layers 12 and 16 indicated.

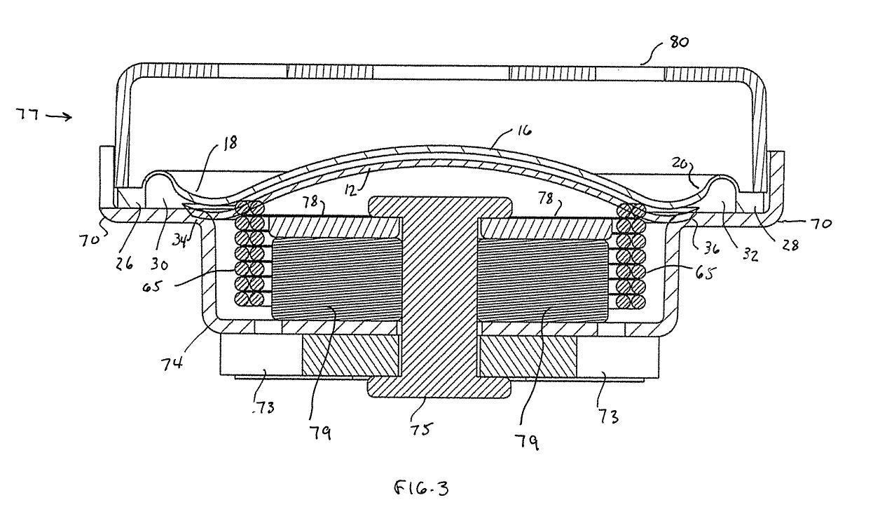

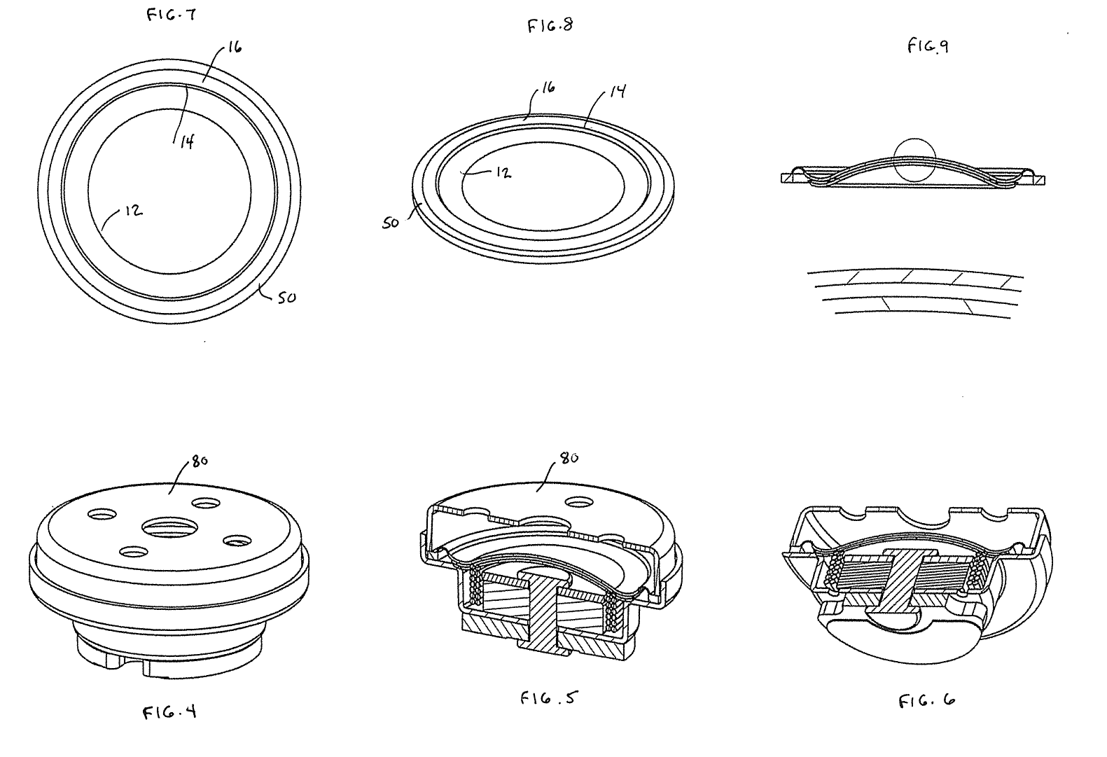

With respect to the incorporation of the sound screen into the earphone or headphone housing assembly, FIG. 4 show the housing assembly 77 with its cover 80, FIG. 5 illustrates the assembly with the cover 80 partially removed and in conformity with the view of FIG. 3, and FIG. 6 shows an underside perspective view of the FIG. 3 arrangement complementing that of FIG. 5. FIG. 7 essentially repeats the configuration of FIG. 1A, along with the porous layer 12 and the nonporous elastic polymer substrate 16 being joined together by the adhesive bonding agent 14. As illustrated in FIGS. 5 and 6, the acoustic absorbers forming the sound screen of the invention are arranged in a circular configuration, formed of two matching semi-circular halves joined with their open ends facing inwardly, one towards another. When so arranged, the acoustic absorbers are crimped at their ends to the surrounding metal ring (easier than if both ends of the layers 12 and 18 would be if the two layers were of the same length to being with) to take on the top view configuration shown at FIG. 9—the sound screen—with the porous layer 12 laminated by the adhesive bonding agent 14 to the nonporous substrate 16 overlying the layer 12 and the bonding agent 14. FIG. 8 illustrates the same layers, with their respective circumference edges raised into the arched domed shape of FIG. 1 in forming the sound screen. In such manner, along with the surrounding metal ring frame, support is provided to the inside layers in forming the sound screen “as a single structure”.

With the two layers of the acoustic absorber then—the substrate nonporous elastic polymer layer 16 (with or without the hole 39 in the middle), and the porous layer 12 being of different material, vibrate differently. Specifically, the vibration of the substrate nonporous elastic polymer layer will be more than that of the porous layer as elastic, more pliable material vibrates more than rigid materials. With the more rigid porous layer (laceable with reenforced gravity or graphite or similar materials or not) becomes the main area for higher pitch frequencies. Such porous layer vibrates, but does not touch the housing at all nor the metal frame so that the vibrations itself from such linkage is a better internal loss of undesired sound because the elastic polymer layer is soft. As a result, a deeper resonance to desired frequencies can be had. Because the two layers are drawn separately to their dome shapes, and because they are cut separately, the thicknesses can be varied as well as the shapes of the acoustic absorbers, so that a greater control of the performance can be had.

While there have been described what are considered to be preferred embodiments of the present invention, it will be readily appreciated by those skilled in the art that modifications can be made without departing from the scope of the teachings herein. For example, while optimum performance has been found to be achievable where the outside diameter of the nonporous elastic polymer substrate layer 16 of the sound screen is greater at its ends 18, 20 than at the ends 34, 36 of the porous layer 12 in the sound screen, acceptable performance is still achievable if their outside diameters at such points in the sound screen were the same. Similarly, if the thicknesses of the layers at the arched dome area were the same instead of the thickness of the layer 12 being greater as described, a somewhat less effectiveness in the acoustic absorbing, sound screening effect would result. For at least such reasons, therefore, resort should be had to the claims appended hereto for a true understanding of the scope of the invention.

We claim:

1. An acoustic absorber for sound screen implementation in earphones and headphones comprising:
a layer of nonporous elastic polymer of a first length;
a layer of porous material of a second length; and
means adhesively securing said layer of porous material beneath said layer of nonporous plastic polymer in a defined composite lamination; and
with intermediate portions of said layer of nonporous elastic polymer material and said layer of porous material in said defined composite lamination being correspondingly raised with respect to opposite ends of each of said layer lengths.

2. The acoustic absorber of claim 1 wherein said layer of porous material is of a shorter length than said nonporous elastic polymer, and is substantially centered between opposite ends of said layer of nonporous elastic polymer in said defined composite lamination.

3. The acoustic absorber of claim 1 wherein said layer of porous material is thinner at said raised central portion than said layer of nonporous elastic polymer at a raised central portion thereof.

4. The acoustic absorber of claim 1 wherein said layer of nonporous elastic polymer and said layer of porous material are each pre-cut to said first and second shorter lengths, respectively.

5. The acoustic absorber of claim 1 wherein said layer of nonporous elastic polymer and said layer of porous material are each drawn and pre-cut to said first and second shorter lengths, respectively.

6. The acoustic absorber of claim 1 wherein said layer of nonporous elastic polymer and said layer of porous material are each drawn and pre-cut to said first and second lengths, respectively, and of diameters greater at opposite ends thereof than where correspondingly centrally raised.

7. The acoustic absorber of claim 2 wherein said layer of nonporous elastic polymer and said layer of porous material are each drawn and pre-cut to said first and second shorter lengths, respectively, and of diameters greater at opposite ends thereof than where correspondingly centrally raised.

8. The acoustic absorber of claim 3 wherein said layer of nonporous elastic polymer and said layer of porous material are each drawn and pre-cut to said first and second lengths, respectively, are of diameters greater at opposite ends thereof than where correspondingly centrally raised, and wherein said second length is shorter than said first length.

9. The acoustic absorber of claim 7 wherein said layer of porous material is substantially centered between opposite ends of said layer of nonporous plastic polymer in said defined composite lamination; and
wherein said layer of porous material is thinner at said raised central portion than said layer of nonporous elastic polymer at a raised central portion thereof.

10. The acoustic absorber of claim 1 also including a second layer of nonporous elastic polymer adhesively secured to an underside of said layer of porous material, and correspondingly raised with said porous layer at said raised central portion thereof.

11. The acoustic absorber of claim 1 wherein said layer of nonporous elastic polymer is composed of a continuous unitary length between said opposite ends thereof.

12. The acoustic absorber of claim 1 wherein said layer of nonporous elastic polymer is composed of a first and second section extending from opposing ends thereof towards said intermediate portion of said layer of nonporous elastic polymer.

13. A sound screen for earphones and headphones comprising:
a plurality of acoustic absorbers formed in a pair of inwardly facing complementing halves, each of said plurality of acoustic absorbers including a layer of nonporous elastic polymer of a first length; a layer of porous material of a second length; and means adhesively securing said layer of porous material beneath said layer of nonporous plastic polymer in a defined composite lamination with intermediate portions of said layer of nonporous elastic polymer material and said layer of porous material in said defined composite lamination being correspondingly raised with respect to opposite ends of each of said layer lengths; and
a metal frame coupled with said layers of nonporous plastic polymers of each of said plurality of acoustic absorbers in both complementing halves.

14. The sound screen of claim 13 wherein said layer of porous material in each of said plurality of acoustic absorbers is substantially centered between opposite ends of each of said layers of nonporous elastic polymer in each of said pair of inwardly facing complementing halves.

15. The sound screen of claim 13 wherein said layer of porous material in each of said plurality of acoustic absorbers is thinner at said raised central portion thereof than said layer of nonporous elastic polymer at a comparable raised central portion of said nonporous elastic polymer.

16. The sound screen of claim 13 wherein said second length is shorter than said first length and wherein said layer of porous material in each of said plurality of acoustic absorbers is substantially centered between opposite ends of each of said layers of nonporous elastic polymer in each of said pair of inwardly facing complementing halves.

17. The sound screen of claim 16 wherein said layer of porous material in each of said plurality of acoustic absorbers is thinner at said raised central portion thereof than said layer of nonporous elastic polymer at a comparable raised central portion of said nonporous elastic polymer.

18. The acoustic absorber of claim 1 wherein said layer of nonporous elastic polymer is of a pliability and stretchability greater than that of said layer of porous material.

19. The sound screen of claim 13 wherein said layers of nonporous elastic polymer in each of said plurality of acoustic absorbers are of a pliability and stretchability greater than that of each of said layers of porous material in each of said plurality of acoustic absorbers.
